(19) United States
(12) Patent Application Publication
(10) Pub. No.: US 2025/0068663 A1
(43) Pub. Date: Feb. 27, 2025

(54) STRING FILTER DEVICE AND OPERATING METHOD THEREOF

(71) Applicant: SK hynix Inc., Gyeonggi-do (KR)

(72) Inventors: Joo Young KIM, Gyeonggi-do (KR); Tae Young AHN, Gyeonggi-do (KR); Soo Hong AHN, Gyeonggi-do (KR)

(21) Appl. No.: 18/738,064

(22) Filed: Jun. 10, 2024

(30) Foreign Application Priority Data
Aug. 25, 2023 (KR) 10-2023-0111997

(51) Int. Cl. G06F 16/335

(52) U.S. Cl. CPC G06F 16/335

(57) ABSTRACT

A string filter device may include an input buffer group and a string comparator group. The input buffer group may store a plurality of string group data segments. Each of the plurality of string group data segments has a first size and includes a plurality of string data having a variable size. The string comparator group may extract a plurality of different sub-string group data segments having a second size among the plurality of string group data segments, and compare, in parallel, each of the plurality of sub-string group data segments with query data, using a plurality of string comparators.

### CROSS-REFERENCE TO RELATED APPLICATION

The present application claims priority under 35 U.S.C. § 119 (a) to Korean patent application number 10-2023-0111997 filed on Aug. 25, 2023, the entire disclosure of which is incorporated by reference herein.

### BACKGROUND

### 1. Field of Invention

Embodiments of the present disclosure generally relate to an electronic device, and more particularly, to a string filter device and an operating method thereof.

### 2. Description of Related Art

A storage device is a device which stores data under the control of a host such as a computer or a smart phone. The storage device may include a memory device for storing data and a memory controller for controlling the memory device. The memory device is classified into a volatile memory device and a nonvolatile memory device.

An operation of a central processing unit (CPU) of a host-side is performed through a dedicated operation unit of a storage device side instead of the CPU of the host side, so that burden of the CPU of the host-side can be reduced. The storage device side transmits only a filtering result value to the CPU of the host-side, so that energy consumption according to data transmission between both sides can be reduced, and performance can be improved.

A filtering operation is an operation of extracting only data having a desired condition from a database. A string filter may extract data which accords with query data or includes the query data.

### SUMMARY

Embodiments of the present disclosure provide a high-speed string filter device through a parallel operation and an operating method thereof.

In accordance with an embodiment of the present disclosure, there is provided a string filter device including: an input buffer group configured to store a plurality of string group data segments, each of the plurality of string group data segments having a first size and including a plurality of string data segments having a variable size; and a string comparator group configured to extract a plurality of different sub-string group data segments having a second size among the plurality of string group data segments, and compare, in parallel, each of the plurality of sub-string group data segments with query data segments, using a plurality of string comparators.

In accordance with another embodiment of the present disclosure, there is provided a string filter device including: a data buffer group receiving and storing a plurality of string group data segments having a fixed size to be synchronized with a reference cycle, each of the plurality of string group data segments including a plurality of string data segments having a variable size; an offset buffer group configured to receive and store a plurality of offset data segments indicating a start position of each of the plurality of string data segments to be synchronized with the reference cycle; a validity buffer group configured to receive and store a plurality of validity data segments indicating validity of each of the plurality of offset data segments to be synchronized with the reference cycle; and a synchronizer configured to adjust a data processing synchronization between the data segments buffer group and the offset buffer group, based on a comparison result of a number of string data segments remaining when target data segments is extracted from the data segments buffer group and a number of offset data segments remaining when the target data segments is extracted from the offset buffer group in a first cycle of the reference cycle.

In accordance with still another embodiment of the present disclosure, there is provided a method of operating a string filter device, the method comprising: receiving a plurality of string group data segments to be synchronized with a reference cycle, each of the plurality of string group data segments having a first size and including a plurality of string data segments having a variable size; extracting a plurality of sub-string group data segments having a second size from string group data corresponding to multi-cycles of the reference cycle; comparing, in parallel, each of the plurality of sub-string group data segments with query data and outputting each comparison result; and extracting target data corresponding to the query data in the comparison result, based on offset data indicating a start position of each string data and validity data indicating validity of the offset data.

These and other features and advantages of the invention will become apparent from the detailed description of embodiments of the present disclosure and the following figures.

### BRIEF DESCRIPTION OF THE DRAWINGS

Various embodiments of the present disclosure will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a diagram illustrating a string filter device in accordance with an embodiment of the present disclosure.

FIG. 2 is a diagram illustrating string group data including a plurality of string data segments and a plurality of sub-string group data segments, and illustrating a parallel comparison operation of the plurality of sub-string group data segments and query data, in accordance with an embodiment of the present disclosure.

FIG. 3 is a diagram illustrating a structure of an input buffer group in accordance with an embodiment of the present disclosure.

FIG. 4A is a diagram illustrating offset data, modified offset data, validity data, and a string data size in accordance with an embodiment of the present disclosure.

FIG. 4B is a diagram illustrating offset data, modified offset data, validity data, and a string data size in accordance with an embodiment of the present disclosure.

FIG. 4C is a diagram illustrating modified offset data, range validity data, and modified validity data in accordance with an embodiment of the present disclosure.

FIG. 5 is a diagram illustrating a data processing synchronization control of a data buffer and an offset buffer according to a number of string data segments remaining after processing and a number of offset data remaining after processing in the same cycle, in accordance with an embodiment of the present disclosure.

FIG. 6 is a diagram illustrating an operation of a string comparator included in a string comparator group shown in FIG. 2.

FIG. 7 is a diagram illustrating an operation of a result processor shown in FIG. 1.

FIG. 8 is a flowchart illustrating an operation of the string filter device in accordance with an embodiment of the present disclosure.

FIG. 9 is a flowchart illustrating an operation of the string filter device in accordance with an embodiment of the present disclosure.

### DETAILED DESCRIPTION

The specific structural or functional description disclosed herein is

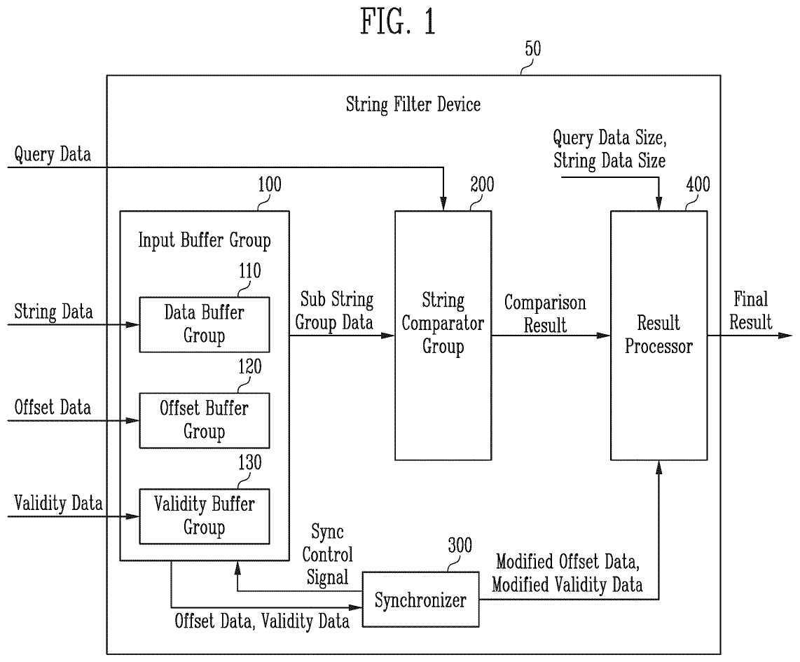

merely illustrative for the purpose of describing embodiments according to the concept of the present disclosure. The embodiments according to the concept of the present disclosure can be implemented in various forms, and should not be construed as limited to the embodiments set forth herein. FIG. 1 is a diagram illustrating a string filter device 50 in accordance with an embodiment of the present disclosure.

Referring to FIG. 1, the string filter device 50 may include an input buffer group 100, a string comparator group 200, a synchronizer 300, and a result processor 400.

The input buffer group 100 may include a data buffer group 110, an offset buffer group 120, and a validity buffer group 130.

The data buffer group 110 may receive and store string group data including a plurality of string data segments having a variable size. The string group data may have a first size determined based on a bandwidth of a channel through which the string group data is received.

The offset buffer group 120 may receive and store offset data indicating a start position of string data.

The validity buffer group 130 may receive and store validity data indicating validity of offset data.

The string comparator group 200 may extract a plurality of different sub-string group data segments having a second size, among string group data of at least two cycles, stored in the data buffer group 110. The second size may be determined based on the maximum size of query data which the string comparator group 200 can process.

Specifically, the string comparator group 200 may extract a plurality of sub-string group data segments such that each character is sequentially shifted from a portion of string group data of a first cycle and string group data of a second cycle among the at least two cycles.

The string comparator group 200 may compare, in parallel, each of the plurality of sub-string group data segments with query data and output a comparison result. The query data may be data satisfying a filtering condition.

The string comparator group 200 may include a plurality of string comparators (not shown). The plurality of string comparators may receive a plurality of sub-string group data segments input in parallel, and output a comparison result of the input sub-string group data segments and query data. The comparison result may indicate whether the query data is included in the sub-string group data segments. The synchronizer 300 may adjust synchronization (sync) between the data buffer group 110 and the offset buffer group 120 through a sync control signal, based on a comparison result of a number of string data segments remaining after processing in the data buffer group 110 and a number of offset data segments remaining after processing in the offset buffer group 120, in the same cycle. A reason why the synchronizer 300 adjusts the sync between the data buffer group 110 and the offset buffer group 120 is that numbers of data segments input in the same cycle may be different from each other since string data input to the data buffer group 110 has a variable size but offset data input to the offset buffer group 120 has a fixed size.

The synchronizer 300 may update at least one of the data buffer group 110 and the offset buffer group 120, based on the comparison result of the number of string data segments remaining after processing and the number of offset data segments remaining after processing, in the same cycle, thereby adjusting a data processing sync between both groups. The updated at least one buffer group may process input data of a next cycle.

The synchronizer 300 may generate modified offset data, based on the first size which the offset data and the string group data have. The synchronizer 300 may generate modified validity data, based on validity data and range validity data indicating a range of offset data to be processed in a current cycle.

The result processor 400 may extract target data matched to the query data, based on the comparison result received from the string comparator group 200 and the modified offset data and the modified validity data which are received from the synchronizer 300.

The result processor 400 may extract target data which accords with the query data or includes the query data according to an operation mode, based on a comparison result of a string data size and a query data size. The operation mode may include a full mode and a start mode. The full mode may be a mode in which data which accords with the query data is filtered, and the start mode may be a mode in which data which starts with the query data is filtered.

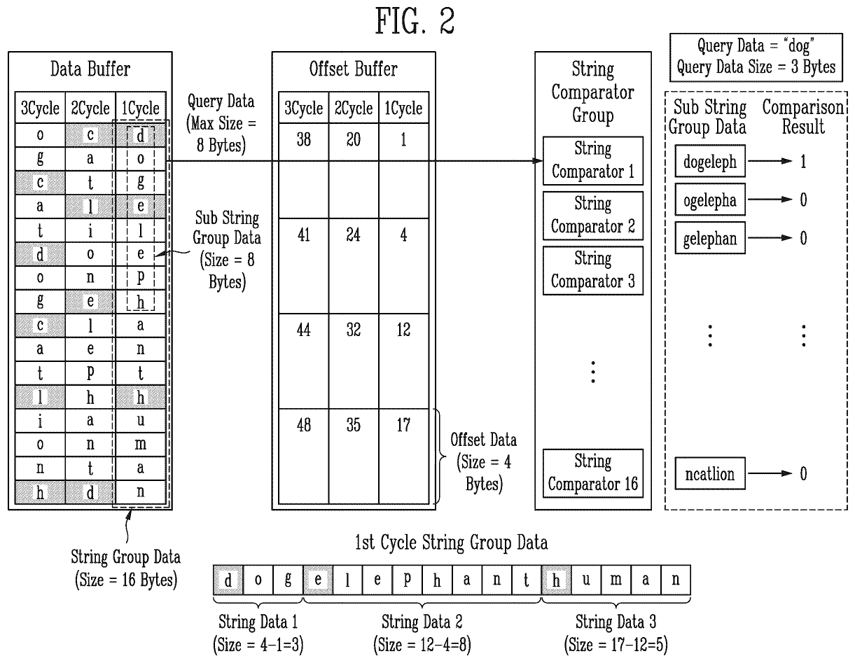

FIG. 2 is a diagram illustrating string group data including a plurality of string data segments and a plurality of sub-string group data segments, and illustrating a parallel comparison operation of the plurality of sub-string group data segments and query data, in accordance with an embodiment of the present disclosure.

Referring to FIG. 2, a data buffer may receive and store string group data having a first size for each cycle. The first size may be determined based on a bandwidth of a channel through which the string group data is received. In FIG. 2, the first size is 16 bytes, but may be set to another value.

The size of the string group data is fixed to the first size, but string group data of each cycle may include a plurality of string data segments having a variable size. Therefore, the number of string data segments included in string group data of each cycle and the size of each string data segment may vary.

For example, string group data of a first cycle is ‘dogelephanthuman,’ and may include three string data segments ‘dog,’ ‘elephant,’ and ‘human.’

The three string data segments may have sizes of 3 bytes, 8 bytes, and 5 bytes. The size of each string data segment may also be calculated as a difference value of corresponding offset data. String group data of a third cycle is ‘ogcatdogcatlionh,’ and may include four string data ‘cat,’ ‘dog,’ ‘cat,’ and ‘lion.’ The four string data segments may have sizes of 3 bytes, 3 bytes, 3 bytes, and 4 bytes.

An offset buffer may receive and store a plurality of offset data segments for each cycle. First offset data may indicate 1 as ‘d’ which is a start position of ‘dog’ as first string data. Second offset data may indicate 4 as ‘e’ which is a start position of ‘elephant’ as second string data. Third offset data may indicate 12 as ‘h’ which is a start position of ‘human’ as third string data.

The plurality of offset data segments may correspond to the first size. This is because bandwidths of channels through which the offset buffer and the data buffer receive data are the same. One offset data may have a predetermined size. In FIG. 2, the size of the offset data may be fixed to 4 bytes. Therefore, since the size of data input in one cycle is 16 bytes, four offset data segments per cycle may be input to the offset buffer.

Since string data has a variable size, the number of string data segments input for each cycle may vary. On the other hand, since offset data has a fixed size, the number of offset data segments input for each cycle may be the same.

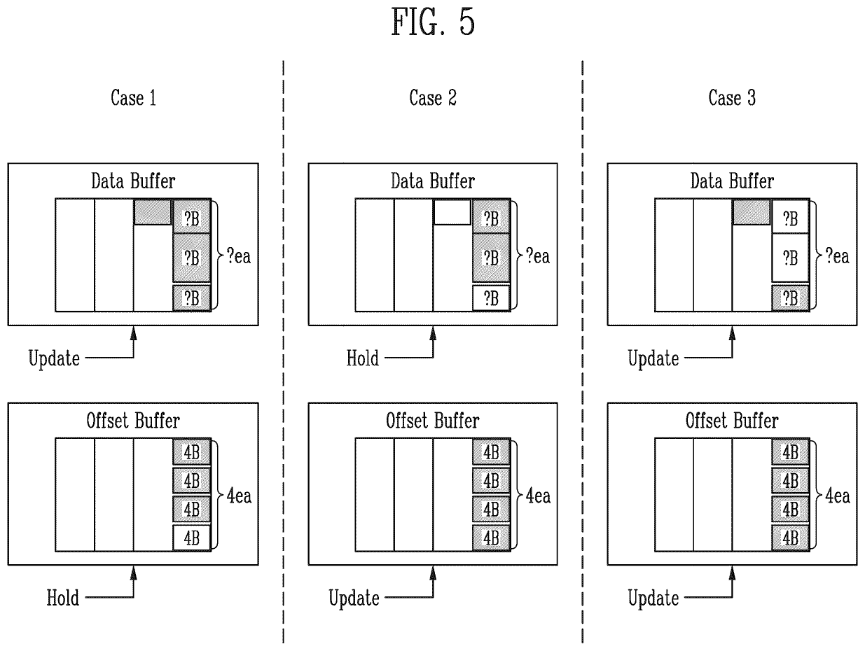

Therefore, the offset data is data indicating a start position of the string data and has a one-to-one correspondence relationship. However, the number of string data segments input for each cycle and the number of offset data segments input for each cycle are different from each other, there may occur a concern in that a data processing sync between the data buffer and the offset buffer is incorrect. To address this concern, a time is used at which the data buffer and the offset buffer are updated, which will be described later in FIG. 5.

A string comparator group may include a plurality of string comparators. A number of string comparators included in the string comparator group may be determined based on the size of string group data input in one cycle. For example, when string group data of 16 bytes is input in one cycle, the size of string data has a minimum of 1 byte to a maximum of 16 bytes. Therefore, to process a case where 16 string data segments each having 1 byte in one cycle are input, the string comparator group includes 16 string comparators.

A plurality of sub-string group data segments may be extracted from a portion of string group data of a first cycle and string group data of a second cycle. The sub-string group data may have a second size, and the second size may be a maximum query size which the string comparator can process. In FIG. 2, it is described that the second size is 8 bytes.

The reason why the string group data of the second cycle is also included in a range in which the plurality of sub-string group data segments are extracted is that, when a query size processed by the string comparator is 2 bytes or more, the range of sub-string group data processed by the string comparator group is beyond a string group data range of a current cycle.

In FIG. 2, 16 sub-string group data segments may be extracted from the string group data of the first cycle, which is 16 bytes, and the string group data of the second cycle, which is 7 bytes. First sub-string group data segment may be ‘dogeleph.’ Second sub-string group data segment may be ‘ogelepha.’ Third sub-string group data segment may be ‘gelephan.’ In this manner, the sixteenth sub-string group data segment may be ‘ncatlion.’ As described above, the first to sixteenth sub-string group data segments may be extracted in a direction in which each character is sequentially shifted to the right. In accordance with another embodiment, the first to sixteenth sub-string group data segments may be extracted in a direction in which each character is sequentially shifted to the left.

The sixteen string comparators included in the string comparator group may sequentially compare sub-string group data input thereto with ‘dog’ as query data from a first character. When the query data and the sub-string group data, ‘dog as a first character of the first sub-string group data segment accords with ‘dog’ as the query data. Therefore, only a first string comparator may output a particular logic value (e.g., 1) as a comparison result, and second to sixteenth string comparators may output a particular logic value (e.g., 0) as a comparison result.

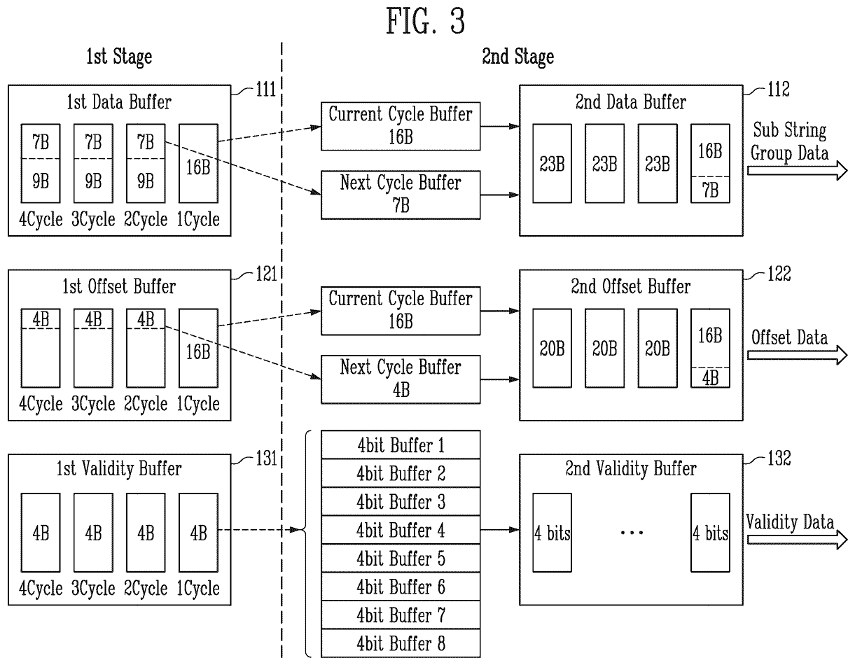

FIG. 3 is a diagram illustrating a structure of the input buffer group 100 in accordance with an embodiment of the present disclosure.

Referring to FIGS. 1 and 3, the input buffer group 100 may include the data buffer group 110, the offset buffer group 120, and the validity buffer group 130.

The data buffer group 110 may include a first data buffer 111 and a second data buffer 112. The offset buffer group 120 may include a first offset buffer 121 and a second offset buffer 122. The validity buffer group 130 may include a first validity buffer 131 and a second validity buffer 132.

As described above in FIG. 2, when the query size processed by the string comparator is 2 bytes or more, the range of sub-string group data processed by the string comparator group is beyond a range of string group data of a current cycle, and hence it is necessary for a portion of string group data of a next cycle to be also used in target data extraction.

Therefore, a portion of string group data of the first cycle and string group data of the second cycle, which are stored in the first data buffer 111, may be stored to be used in target data extraction in the same cycle in the second data buffer 112.

In FIG. 2, the maximum query size supported by the string comparator (hardware architecture) is 8 bytes, the second data buffer 112 may handle, as one string group data, the string group data segments of the current cycle (i.e., 16 bytes) and a portion of the string group data segments of the next cycle (i.e., 7 bytes), and store the one string group data.

Offset data is data indicating a start position of the string data and has a one-to-one correspondence relationship. Hence, the offset data may be equally handled. Therefore, a portion of a plurality of offset data segments of the first cycle and a plurality of offset data segments of the second cycle, which are stored in the first offset buffer 121, may be stored to be used in target data extraction in the same cycle in the second offset buffer 122.

The second offset buffer 122 may handle, as one offset data group, the plurality of offset data segments of the current cycle (i.e., 4 offset data segments (16 bytes)) and one or more offset data segments of the next cycle (i.e., one offset data segment (4 bytes)), and store the one offset data group. The offset data segment may have a size fixed to 4 bytes.

Validity data is data indicating validity of the offset data segment and has a one-to-one correspondence relationship. However, while one offset data segment has a size fixed to 4 bytes, the validity data may have a size of 1 bit, which indicates validity/invalidity.

Therefore, although validity data and offset data are identically input in one cycle, a size of the validity data is smaller than a size of the offset data segment, and hence validity data input in one cycle may have a corresponding relationship with offset input in several cycles.

For example, when four offset data segments are input in one cycle, validity data of 4 bits is required. Since validity data of 4 bytes is input in one cycle as shown in FIG. 2, the validity data is validity data of 4*8=32bits, and therefore, 4 bytes as validity data input in the first cycle may be used until 32 offset data segments corresponding to a total of eight cycles is input.

The second validity buffer 132 may divide the validity data of 4 bytes, which is received from the first validity buffer 131, in a 4-bit unit to be matched one-to-one to offset data segments of the same cycle, thereby storing the divided validity data.

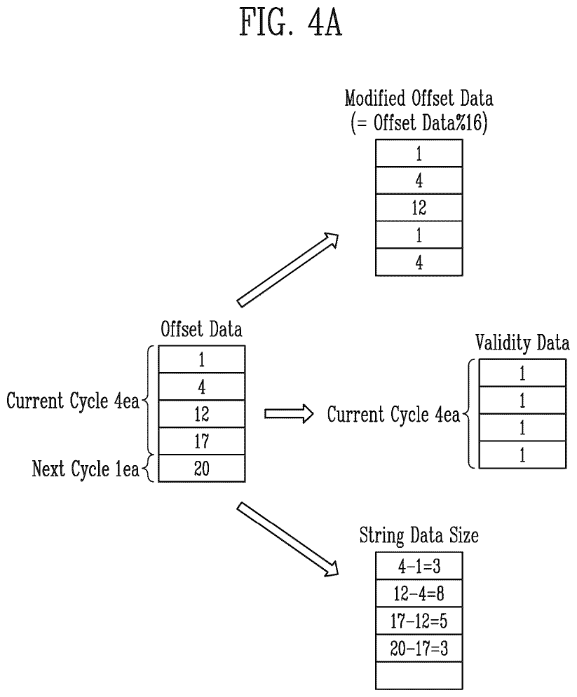

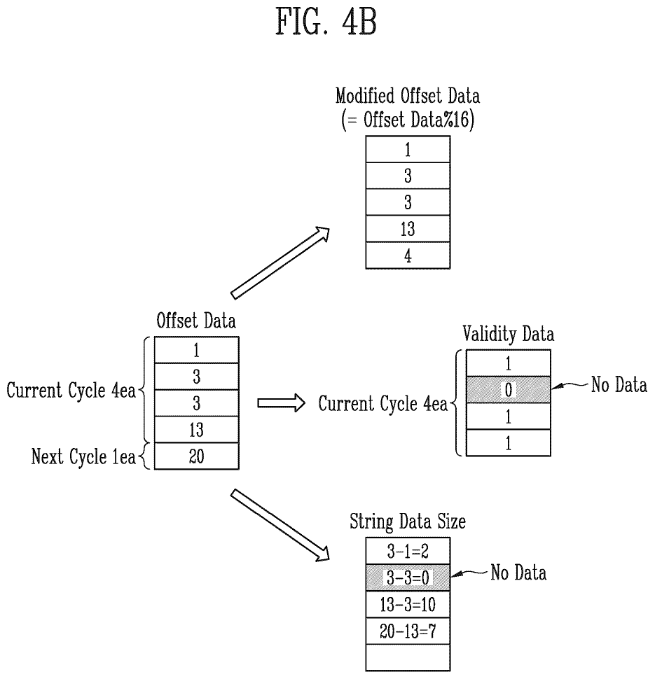

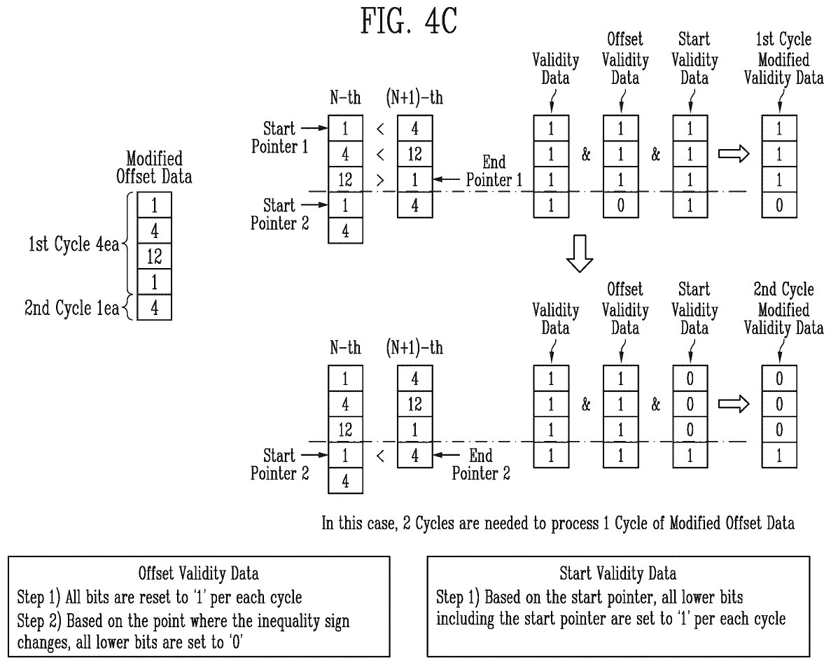

FIG. 4A is a diagram illustrating offset data, modified offset data, validity data, and a string data size in accordance with an embodiment of the present disclosure.

Referring to FIG. 4A, each offset data segment is data indicating a start position of string data.

In FIG. 4A, four offset data segments input in a current cycle may be ‘1, 4, 12, and 17,’ and one offset data input segment in a next cycle may be ‘20.’

Modified offset data segments may have a value obtained by performing a modulo or modular (MOD) operation on the offset data segments, using a number of characters input in one cycle (e.g., 16 mod×(=1, 4, 12, 17 and 20)). Accordingly, each modified offset data segment may indicate a position within a number range of characters input in one cycle even when a value of the offset data segments increases as the cycle increases. The modified offset data segments may be ‘1, 4, 12, 1, and 4.’

Validity data may be data indicating validity of the offset data. When current offset data is greater than previous offset data, this indicates that the start position of the string data is modified. Since this indicates that string data exists, the validity data may indicate ‘1.’ The validity data may be ‘1, 1, 1, and 1.’

A string data size may be a value obtained by subtracting the current offset data (i.e., offset data segment of the current cycle) from next offset data (i.e., offset data segment of the next cycle). That is, the string data size may be calculated using a difference between start position values of string data. String data sizes may be ‘3, 8, 5, and 3.’ When the offset data is the offset data shown in FIG. 2, the string data size corresponds to a size of ‘dog,’ ‘elephant,’ ‘human,’ ‘cat,’ or the like as described above.

FIG. 4B is a diagram illustrating offset data, modified offset data, validity data, and a string data size in accordance with an embodiment of the present disclosure.

Referring to FIG. 4B, unlike the input offset data in FIG. 4A, in FIG. 4B it is described that offset data are ‘1, 3, 3, 13, and 20.’ Modified offset data may be ‘1, 3, 3, 13, and 4.’ Validity data may be ‘1, 0, 1, and 1.’ String data sizes may be ‘2, 0, 10, and 7.’

As compared with FIG. 4A, when the current offset data is equal to the previous offset data, this indicates that the start position of the string data is not modified. Since this indicates that string data does not exist, the validity data may indicate ‘0.’ In addition, for the same reason, since string data does not exist, the string data may also indicate ‘0.’

FIG. 4C is a diagram illustrating modified offset data, range validity data, and modified validity data in accordance with an embodiment of the present disclosure.

Referring to FIG. 4C, modified offset data may be data obtained by performing a MOD operation on offset data indicating a start point of string data, using a number of characters input in one cycle.

Range validity data may include offset validity data and start validity data. The offset validity data may indicate a position of an end pointer of offset data to be used in target data extraction in a current cycle among a plurality of offset data segments. The start validity data may indicate a position of a start pointer of the offset data segment to be used in the target data extraction in the current cycle, among the plurality of offset data segments.

In the offset validity data, all bits are reset to ‘1’ per each cycle, and all lower bits at a point at which an inequality sign is changed are set to ‘0’ when comparing an Nth value and an (N+1)th value of the modified validity data.

In the start validity data, all lower bits including the start pointer are set to ‘1,’ and the other bits are set to ‘0.’

The modified validity data may be generated by performing an AND operation on the validity data and the range validity data. In FIG. 4C, the modified validity data will be described. It can be seen that only a range of the offset data to be used in the target data extraction in the current cycle among the validity data is indicated as ‘1.’

FIG. 5 is a diagram illustrating a data processing synchronization control of a data buffer and an offset buffer according to a number of string data remaining after processing and a number of offset data remaining after processing in the same cycle in the same cycle, in accordance with an embodiment of the present disclosure.

Referring to FIG. 5, the synchronizer may adjust a sync between a data buffer and an offset buffer. Since string data has a variable size but offset data has a fixed size, a number of string data segments input to the data buffer and a number of offset data segments input to the offset buffer in the same cycle may be different from each other.

In the case of Case 1, in the same cycle, string data may be in a state in which all string data segments are processed in the data buffer. In the same cycle, offset data may be in a state in which three offset data segments are processed and one offset data segment remains in the offset buffer. That is, a number of string data segments remaining after processing in the data buffer may be 0, and a number of offset data segments remaining after processing in the offset buffer may be 1. Therefore, since the number of remaining string data segments is less than the number of remaining offset data segments, the synchronizer may update the data buffer. In the updated data buffer, string data of a next cycle may be used in target data extraction.

In the case of Case 2, in the same cycle, string data may be in a state in which some of the string data segments are processed and one or more string data segments remain in the data buffer. In the same cycle, offset data may be in a state in which all offset data segments are processed in the offset buffer. Therefore, since a number of remaining string data segments is greater than a number of remaining offset data segments, the synchronizer may update the offset buffer. In the updated offset buffer, offset data segments of a next cycle may be used in target data extraction.

In the case of Case 3, in the same cycle, string data may be in a state in which all string data segments are processed in the buffer data. In the same cycle, offset data may be in a state in which all offset data segments are processed in the offset buffer. Therefore, since a number of remaining string data segments is equal to a number of remaining offset data segments, the synchronizer may update both the data buffer and the offset buffer. In the updated data buffer, string data of a next cycle may be used in target data extraction. In the updated offset buffer, offset data of the next cycle may be used in the target data extraction.

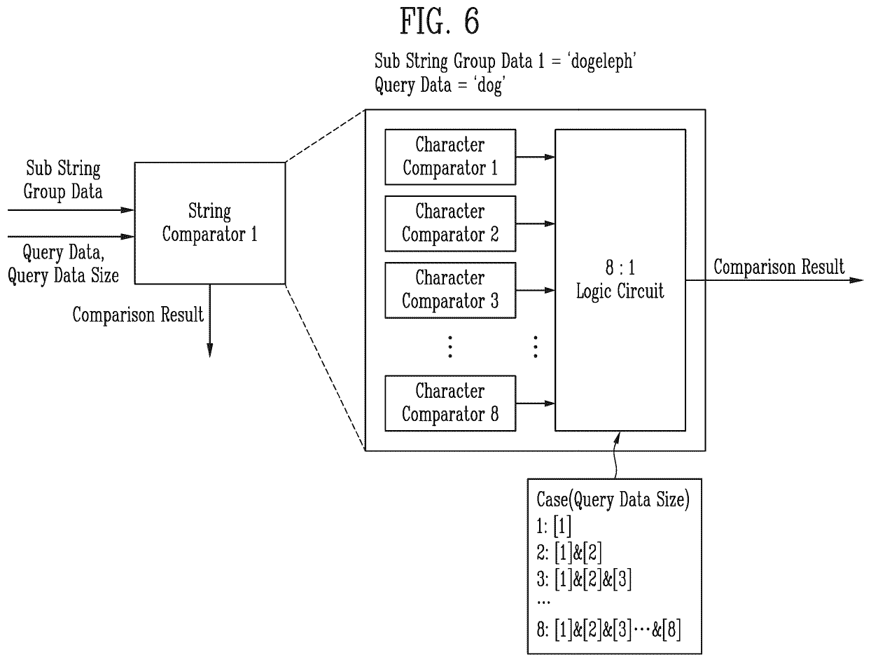

FIG. 6 is a diagram illustrating an operation of the string comparator included in the string comparator group shown in FIG. 2.

Referring to FIGS. 2 and 6, ‘dogeleph’ as first sub-string group data and ‘dog’ as query data may be input to the first string comparator.

The first string comparator may include eight character comparators corresponding to a maximum query data size. Therefore, as for the first sub-string group data, ‘d, o, g, e, l, e., p, and h’ may be separated character by character to be input to first to eighth character comparators. As for the query data, ‘d, o, and g’ may be separated character by character to be input to the first to third character comparators. An output of the first to eighth character comparators may be input to an 8:1 logic circuit, and the logic circuit may output a result as a case sentence according to a query data size.

Therefore, since the size of ‘dog’ as the query data is 3, an AND operation may be performed on only inputs received from the first to third character comparators, thereby outputting a result. Accordingly, since ‘dog’ are the first three characters of the first sub-string group data and ‘dog’ as the query data accord with each other, the first string comparator may output ‘1’ as a comparison result.

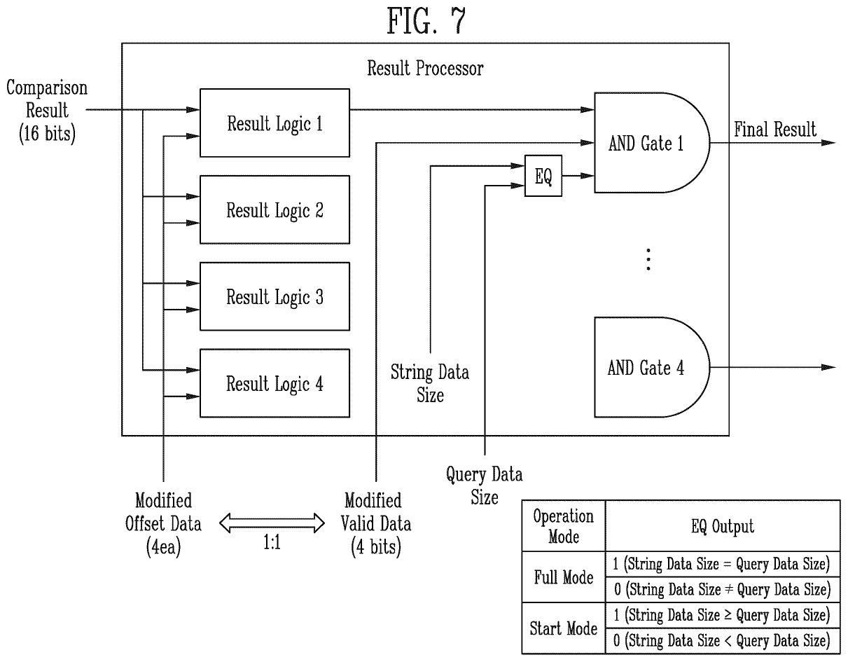

FIG. 7 is a diagram illustrating an operation of the result processor shown in FIG. 1.

Referring to FIG. 7, the result processor may include result logics corresponding to a number of offset data input in one cycle.

As shown in FIG. 2, when the number of offset data input in one cycle is 4, the result processor may include four result logics, and a comparison result of 16 bits may be received from the string comparator group.

The comparison result of 16 bits may be commonly input to first to fourth result logics, and four modified offset data may be sequentially input one by one to the first to fourth result logics. Accordingly, only a bit value corresponding to an offset among the 16 bits included in the comparison result may be selected to be extracted as first data. The first data may be extracted as second data corresponding to a range to be used for target data extraction in a current cycle by performing an AND operation on the first data and modified validity data. The second data may be extracted as target data which accords with query data or is included as the query data according to an operation mode.

For example, when the operation mode is a full mode, only the target data which accords with the query data may be extracted, and is extracted as the target data by performing an AND operation on data having 1 or 0 and the second data according to whether a string data size and a query data size accord with each other.

When the operation mode is a start mode, the target data including query data may be extracted, and is extracted as the target data by performing an AND operation on the data having 1 or 0 and the second data according to whether the string data size is greater than or equal to the query data size. The string data size input to an EQ circuit may be a size of string data corresponding to each modified offset data.

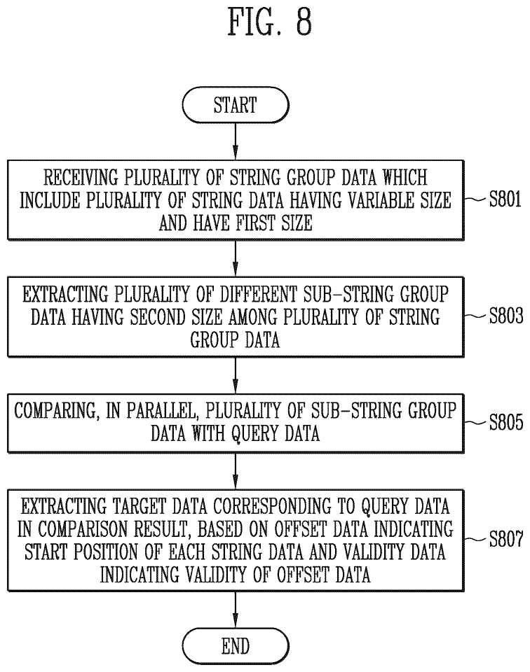

FIG. 8 is a flowchart illustrating an operation of the string filter device in accordance with an embodiment of the present disclosure.

Referring to FIG. 8, in operation S801, the string filter device may receive a plurality of string group data segments which include a plurality of string data segments having a variable size and a first size to be synchronized with a reference cycle. The first size may be determined based on a bandwidth of a channel. For example, the input buffer group of the string filter device may receive the string group data segments having the first size to be synchronized with the reference cycle.

In operation S803, the string filter device may extract a plurality of different sub-string group data segments having a second size, among string group data segments of at least two cycles. The plurality of sub-string group data segments may be extracted to be shifted character by character. The second size may be a maximum query data size which the string filter device can process. For example, the input buffer group may output the plurality of sub-string group data segments extracted to be shifted character by character to the string comparator group of the string filter device.

In operation S805, the string filter device may compare, in parallel, the plurality of sub-string group data segments with query data, and output a comparison result. For example, the string comparator group may output, to the result processor of the string filter device, a result obtained by comparing, in parallel, each of the plurality of sub-string group data segments with the query data.

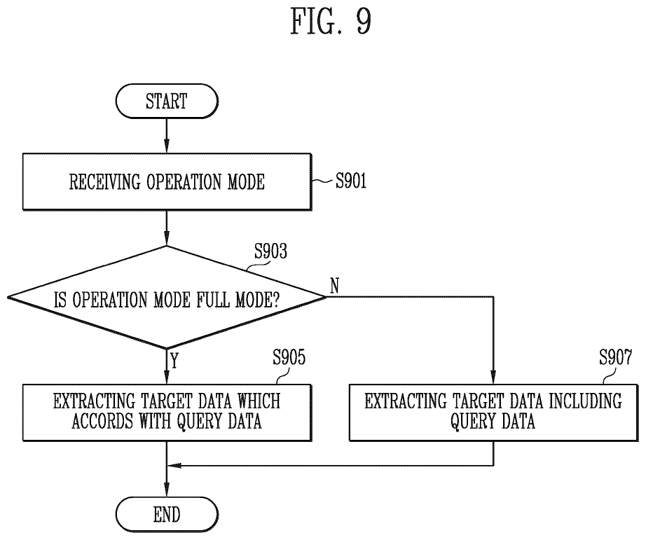

In operation S807, the string filter device may extract target data corresponding to the query data in the comparison result, based on offset data indicating a start position of each string data and validity data indicating validity of the offset data. For example, the result processor may extract the target data from the comparison result received from the string comparator group, based on the offset data and the validity data. The extracting of the target data corresponding to the query data will be described later with reference to FIG. 9.

FIG. 9 is a flowchart illustrating an operation of the string filter device in accordance with an embodiment of the present disclosure.

Referring to FIG. 9, in operation S901, the string filter device may receive information regarding an operation mode for a filtering condition.

The operation mode may include a full mode and a start mode. The full mode may be a mode in which data which accords with query data is filtered, and the start mode may be a mode in which data starting with the query data is filtered.

In operation S903, the string filter device may determine whether the operation mode is the full mode. When the operation mode is the full mode as a determination result (S903, Y), the string filter device may proceed to operation S905. When the operation mode is the start mode (S903, N), the string filter device may proceed to operation S907. For example, referring to FIG. 7, the result processor of the string filter device may compare a string data size and a query data size in different manners according to the operation mode. According to a comparison result received from the string comparator group, the result processor may output, as a valid value or an invalid value, a final result value corresponding to each of bit values of the comparison result.

In the operation S905, the string filter device may extract target data which accords with the query data. For example, when the operation mode is the full mode, the result processor may output the final result value as the valid value when the string data size accords with the query data size. When the string data size does not accord with the query data size, the result processor may output the final result value as the invalid value.

In the operation S907, the string filter device may extract target data including the query data. For example, when the operation mode is the start mode, the result processor may output the final result value as the valid value when the string data size is greater than or equal to the query data size. When the string data size is less than the query data size, the result processor may output the final result value as the invalid value.

In accordance with the embodiments of the present disclosure, there is provided a high-speed string filter device through a parallel operation and an operating method thereof.

While the present disclosure has been shown and described with reference to certain embodiments thereof, it will be understood by those skilled in the art that various changes in form and details may be made therein without departing from the spirit and scope of the present disclosure as defined by the appended claims and their equivalents. Therefore, the scope of the present disclosure should not be limited to the above-described embodiments but should be determined by not only the appended claims but also the equivalents thereof.

In the above-described embodiments, all operations may be selectively performed or part of the operations may be omitted. In each embodiment, the operations are not necessarily performed in accordance with the described order and may be rearranged. The embodiments disclosed in this specification and drawings are only examples to facilitate an understanding of the present disclosure, and the present disclosure is not limited thereto. That is, it should be apparent to those skilled in the art that various modifications can be made on the basis of the technological scope of the present disclosure.

The embodiments of the present disclosure have been described in the drawings and specification. Although specific terminologies are used here, those are only to describe the embodiments of the present disclosure. Therefore, the present disclosure is not restricted to the above-described embodiments and many variations are possible within the spirit and scope of the present disclosure. It should be apparent to those skilled in the art that various modifications can be made on the basis of the technological scope of the present disclosure in addition to the embodiments disclosed herein. Furthermore, the embodiments may be combined to form additional embodiments.

What is claimed is:

1. A string filter device comprising:
an input buffer group configured to store a plurality of string group data segments, each of the plurality of string group data segments having a first size and including a plurality of string data segments having a variable size; and
a string comparator group configured to extract a plurality of sub-string group data segments having a second size, among the plurality of string group data segments, and compare, in parallel, each of the plurality of sub-string group data segments with query data, using a plurality of string comparators.

2. The string filter device of claim 1, wherein the input buffer group includes:
a data buffer group configured to store the plurality of string group data segments;
an offset buffer group configured to store offset data indicating a start position of the plurality of string data segments; and
a validity buffer group configured to store validity data indicating validity of the offset data.

3. The string filter device of claim 2, wherein the data buffer group includes:
a first data buffer configured to receive the plurality of string group data segments to be synchronized with a reference cycle, and store the plurality of string group data segments; and
a second data buffer configured to receive the plurality of string group data segments from the first data buffer, and store a portion of string group data segments of a first cycle and string group data segments of a second cycle during the reference cycle.

4. The string filter device of claim 2, wherein the offset buffer group includes:
a first offset buffer configured to receive the offset data to be synchronized with a reference cycle, and store the offset data; and
a second offset buffer configured to receive the offset data from the first offset buffer, and store a portion of offset data segments of a first cycle and offset data segments of a second cycle during the reference cycle.

5. The string filter device of claim 2, wherein the validity buffer group includes:
a first validity buffer configured to receive the validity data to be synchronized with a reference cycle, and store the validity data; and
a second validity buffer configured to receive the validity data from the first validity buffer, and store the validity data divided to be matched one-to-one to the offset data.

6. The string filter device of claim 3, wherein the string comparator group receives the plurality of sub-string group data segments extracted to be shifted character by character from the portion of the string group data segments of the first cycle and the string group data segments of the second cycle, stored in the second data buffer.

7. The string filter device of claim 6, wherein the string comparator group includes the plurality of string comparators configured to receive, in parallel, each of the plurality of sub-string group data segments, and output a comparison result of each of the plurality of sub-string group data segments with the query data.

8. The string filter device of claim 1, wherein the first size is determined based on a bandwidth of a channel through which the string group data segments are received.

9. The string filter device of claim 1, wherein the second size is determined based on a maximum query data size which the string comparator group can process.

10. A string filter device comprising:
a data buffer group configured to receive and store a plurality of string group data segments having a fixed size to be synchronized with a reference cycle, each of the plurality of string group data segments including a plurality of string data segments having a variable size;
an offset buffer group configured to receive and store a plurality of offset data segments indicating a start position of each of the plurality of string data segments to be synchronized with the reference cycle;
a validity buffer group configured to receive and store a plurality of validity data segments indicating validity of each of the plurality of offset data segments to be synchronized with the reference cycle; and
a synchronizer configured to adjust a data processing synchronization between the data buffer group and the offset buffer group, based on a comparison result of a number of string data segments remaining when target data is extracted from the data buffer group and a number of offset data segments remaining when the target data is extracted from the offset buffer group in a first cycle of the reference cycle.

11. The string filter device of claim 10, further comprising:
a string comparator group configured to receive, from the data buffer group, a plurality of sub-string group data segments extracted from the plurality of string group data segments, compare each of the plurality of sub-string group data segments with query data, and output each comparison result; and
a result processor configured to extract target data matched to the query data, based on the comparison result and the plurality of offset data segments,
wherein offset data used when the target data is extracted among the plurality of offset data segments and string data corresponding to the offset data segments used when the target data is extracted are output from the data buffer group and the offset buffer group in the first cycle.

12. The string filter device of claim 10, wherein the synchronizer updates at least one of the data buffer group and the offset buffer group, based on the comparison result of the number of remaining string data segments and the number of remaining offset data segments, and
wherein, in the updated at least one buffer group, data of a second cycle as a next cycle of the first cycle is used when the target data is extracted.

13. The string filter device of claim 12, wherein the synchronizer updates the data buffer group when the number of remaining string data segments is less than the number of remaining offset data segments.

14. The string filter device of claim 12, wherein the synchronizer updates the data buffer group and the offset buffer group when the number of remaining string data segments is equal to the number of remaining offset data segments.

15. The string filter device of claim 12, wherein the synchronizer updates the offset buffer group when the number of remaining string data segments is greater than the number of remaining offset data segments.

16. The string filter device of claim 10, wherein the fixed size is determined based on a bandwidth of a channel through which the string group data is received to be synchronized with the reference cycle.

17. The string filter device of claim 16, wherein the offset buffer group receives and stores the plurality of offset data segments equally having a predetermined size to be synchronized with the reference cycle.

18. The string filter device of claim 17, wherein the offset buffer group determines a number of the plurality of offset data segments received to be synchronized with the reference cycle, based on the fixed size of the string group data and the predetermined size of the plurality of offset data segments.

19. A method of operating a string filter device, the method comprising:
receiving a plurality of string group data segments to be synchronized with a reference cycle, each of the plurality of string group data segments having a first size and including a plurality of string data segments having a variable size;
extracting a plurality of sub-string group data segments having a second size from string group data corresponding to multi-cycles of the reference cycle;
comparing, in parallel, each of the plurality of sub-string group data segments with query data and outputting each comparison result; and
extracting target data corresponding to the query data in the comparison result, based on offset data indicating a start position of each string data and validity data indicating validity of the offset data.

20. The method of claim 19, wherein the extracting the target data includes extracting the target data which accords with the query data or includes the query data according to an operation mode, based on a size of each of the string data and a size of the query data.
